(19) United States
(12) Patent Application Publication
(10) Pub. No.: US 2008/0156230 A1
(43) Pub. Date: Jul. 3, 2008

(54) Method for Producing Transparent Dioxazine Pigments

(76) Inventors: Heino Heckmann, Liederbach (DE); Martin Boehmer, Neu-Anspach (DE); Klaus Brychcy, Frankfurt am Main (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/884,857

(22) PCT Filed: Feb. 22, 2006
(86) PCT No.: PCT/EP2006/001583

§ 371 Date: Aug. 21, 2007

(30) Foreign Application Priority Data
Feb. 25, 2005 (DE) 10 2005 008 659.4

(51) Int. Cl. C08K 5/35; B02C 17/00; B02C 17/14; B02C 19/16

(52) U.S. Cl. 106/498; 241/27; 241/175

(57) ABSTRACT

The invention relates to a method for producing transparent dioxazine pigments. Said method is characterised by the use of an eccentric oscillating mill to crush a dioxazine crude pigment, said mill comprising at least one milling container that is mounted on the oscillating elements and an excitation unit that is rigidly fixed to said milling container. According to the invention, the excitation takes place in an eccentric manner on one side, outside the gravitational axis and the centre of mass of the milling container, thus generating inhomogeneous oscillations consisting of circular, elliptical and linear oscillations.

The invention relates to a new method of comminuting crude dioxazine pigments which uses a vibratory mill having an eccentric vibratory movement.

The comminuting of crude dioxazine pigments has been carried out for a long time and requires specific mills. Besides roll mills, vibratory mills are employed, which are characterized by circular, i.e., centric, vibratory movements. In addition, bead mills are employed for wet milling.

The important parameters when constructing a mill are, on the one hand, the specific energy input, i.e., the fraction of energy applied that performs the actual comminuting work, and, on the other hand, the manner in which this specific energy input is applied. The remaining fraction of the energy essentially performs heating.

Thus roll milling or bead milling is indeed characterized by a very gentle energy transfer mechanism; the comminuting work is transferred principally in the form of frictional energy. A disadvantage, however, is the low specific energy input, which necessitates long milling times for a desired fineness.

Vibratory mills do indeed have a substantially higher specific energy input, which is reflected in drastically shorter milling times and hence more economic methods. The energy, however, is transferred principally by impact, and so milling is a long way from being as gentle as in the case of roll milling.

Excessive mechanical stress in the milling of organic pigments may in principle result in irreversible destruction to the crystal lattice, with the consequence of impaired performance properties, such as reduced weatherfastness or reduced color strength, for example. In the case of milling in a vibratory mill, therefore, there exists an optimum in terms of performance properties, and this optimum ought to be reached as quickly as possible.

The synthesis of dioxazine pigments has been known for a long time. The dioxazine obtained in coarsely crystalline form in the synthesis, and referred to below as crude pigments, have inadequate performance properties which mean that, without comminution, they cannot be used for coloring high molecular mass materials.

The prepigments which form when crude organic pigments are comminuted in roll mills or vibratory mills are distinguished by a primary grain whose particle size distribution is as desired or finer than desired. The primary grains, however, are in such a highly aggregated form that they must first be broken up by an aftertreatment and, if appropriate, converted by means of crystal growth into the desired particle size distribution. For this aftertreatment there are numerous methods known: for example, thermal aftertreatment in a liquid aqueous, organic or aqueous-organic medium, referred to as finishing, or, for example, deaggregation by means of wet dispersion.

The degree of aggregation is dependent on the milling principle used. Thus in the case of roll milling the prepigments which form are commonly less highly aggregated than in the case of vibratory milling. For organic pigments, the aggregation produced by vibratory milling can be so great that it can no longer be reversed by aftertreatment, or can be reversed only at great cost and inconvenience and hence uneconomically.

Milling therefore has a critical influence on the performance properties, such as color strength, cleanness of hue, transparency, gloss, fastness to solvents, light, and weather, and rheology, for example.

DE-B1-27 42 575 discloses a method that uses a vibratory mill for comminuting pigments of the dioxazine series.

Gock, E.; Corell, J., Fortschrittsberichte der Deutschen Keramischen Gesellschaft (2001), 16 (1, Symposium—Neue Entwicklungen in der Keramischen Aufbereitung, 1999), 51-59 describe the use of eccentric vibratory mills for preparing a hiding organic pigment. This was not surprising, since for the reasons outlined above it was obvious to suppose that the more efficient milling achieved by an eccentric vibratory mill would lead to even greater aggregation of the pigment particles than on a conventional vibratory mill. This document, however, does not disclose the organic pigment involved.

Against the background of the aspects outlined, the object was to increase the efficiency involved in the milling of dioxazines, in order to obtain the abovementioned performance properties in a shorter time or better properties in the same time, and in particular to obtain not only transparent but also strongly colored dioxazine pigments.

This object is achieved, surprisingly and contrary to previous experience, through the use of an eccentric vibratory mill.

The invention provides a method for the production of transparent dioxazine pigments, which comprises comminuting a crude dioxazine pigment using an eccentric vibratory mill having at least one milling container mounted on vibratory elements and having an energizer unit fastened rigidly to the milling container, the energizing taking place eccentrically to one side and outside the gravitational axis and the center of gravity of the milling container, so that inhomogeneous vibrations consisting of circular, elliptical, and linear vibrations are generated.

Suitable mill constructions are described for example in EP-A1-0 653 244. Typical vibration amplitudes are up to 20 mm, the motor speed up to 2000 rpm. The rule here is that the higher the motor speed the lower the vibration amplitude. For example: 12 to 13 mm amplitude at 1000 rpm; 5 to 6 mm amplitude at 1500 rpm. The milling tube diameter can be 200 to 1000 mm, the milling tube length 400 to 2000 mm. The specific drive power is dependent on the desired milling effect. For PV 23 it is typically between 0.2 and 8.0 kWh/kg of pigment, for “coatings grades” between 1.8 and 2.5 kWh/kg of pigment, for example.

The dioxazine employed may be the crude dioxazine pigment present directly after the synthesis, which usually still contains up to about 35% of salts formed during the synthesis. These salts originating from the synthesis are commonly removed by means of alkaline and/or acidic aqueous extraction. In the method of the invention it is possible to employ both the crude pigment containing synthesis salt and the crude pigment purified to remove the synthesis salt.

It is also possible to employ a mixture of different dioxazines.

Examples of dioxazine pigments are C.I. Pigment Violet 23, 37 and C.I. Pigment Blue 80.

Preference is given to C.I. Pigment Violet 23 and C.I. Pigment Blue 80.

Transparent dioxazine pigments are understood as being those which have BET surface areas of more than 20 m²/g, particularly of more than 30 m²/g, especially of more than 40 m²/g, and/or whose particle size distributions as determined by electron microscopy are characterized by D50 values of less than 175 nm, in particular less than 150, especially less than 100 nm.

A simple method which can be used for determining the degree of comminution is the color strength, which increases as the degree of comminution goes up. A further possibility is to select from the X-ray scattering spectrum a suitable peak, whose absolute height is set in relation to the absolute height of the background of the spectrum. The quotient obtained in this way serves as an index of the crystallinity (numerical measure of crystal size and crystal quality) and hence of the degree of pigment milling achieved.

In order to be able to compare milling in different mills it is necessary to operate with the same millbase filling level. The millbase filling level is usually 60% to 100% and is defined as the ratio of the volume of the millbase bed at the beginning of milling (crude pigment and any grinding assistant) to the free volume of the bed of grinding media (only the grinding media). The grinding media filling level must also be the same; it is defined as the ratio of the bed of grinding media to the mill volume. In general a grinding media filling level of 50% to 80% is selected.

In the method of the invention the eccentric vibratory mill can be operated either continuously or batchwise; batchwise operation is preferred on the laboratory scale. It is also possible to connect two or more mills in parallel or in series. Suitable grinding media including all those which are typical, examples being balls, cylinders or rods, and suitable materials for the grinding media include steel, porcelain, ceramic, such as steatite, oxides, such as alumina, unstabilized or stabilized zirconium oxide, mixed oxides, such as zirconium mixed oxides, for example, or quartz. The grinding media ought to have a very smooth and pore-free surface. Milling can take place at temperatures of −20 to +200° C., preferably 0 to 150° C., though it is commonly implemented at a temperature between 20 and 100° C. The mill can also be cooled or heated. The residence time in the mill can be for example between 5 minutes and 25 hours, advantageously between 15 minutes and 15 hours, preferably between 30 minutes and 9 hours. Suitable interior mill lining includes wear-resistant reinforcements of steel, elastomer or ceramic.

Milling takes place with or without grinding assistants. Suitable grinding assistants include alkali metal salts or alkaline earth metal salts of inorganic acids, hydrochloric acid or sulfuric acid for example, or of organic acids having 1 to 4 carbon atoms, formic acid and acetic acid for example. Preferred salts are sodium formate, sodium acetate, calcium acetate, sodium chloride, potassium chloride, calcium chloride, sodium sulfate, aluminum sulfate or mixtures of these salts. The grinding assistants can be used in any amount, such as in an amount of up to 5 times, relative to the weight of the crude pigment. Larger amounts can also be used, but are uneconomic.

At the milling stage it is possible to employ organic liquids and solvents. Examples of such liquids and solvents are alcohols having 1 to 10 carbon atoms, such as methanol, ethanol, n-propanol, isopropanol, butanols, such as n-butanol, isobutanol, tert-butanol, pentanols, such as n-pentanol, 2-methyl-2-butanol, hexanols, such as 2-methyl-2-pentanol, 3-methyl-3-pentanol, 2-methyl-2-hexanol, 3-ethyl-3-pentanol, octanols, such as 2,4,4-trimethyl-2-pentanol, cyclohexanol; or glycols, such as ethylene glycol, di-, tri- or tetraethylene glycol, propylene glycol, di-, tri- or tetrapropylene glycol, sorbitol or glycerol; polyglycols, such as polyethylene glycols or polypropylene glycols; ethers, such as methyl isobutyl ether, tetrahydrofuran, dimethoxyethane or dioxane; glycol ethers, such as monoalkyl ethers of ethylene glycol or propylene glycol or diethylene glycol monoalkyl ethers, where alkyl can be methyl, ethyl, propyl, and butyl, examples being butyl glycols or methoxybutanol; polyethylene glycol monomethyl ethers, particularly those having an average molar mass of 350 to 550 g/mol, and polyethylene glycol dimethyl ethers, particularly those having an average molar mass of 250 to 500 g/mol; ketones, such as acetone, diethyl ketone, methyl isobutyl ketone, methyl ethyl ketone or cyclohexanone; aliphatic acid amides, such as formamide, dimethylformamide, N-methylacetamide or N,N-dimethylacetamide; urea derivatives, such as tetramethylurea; or cyclic carboxamides, such as N-methylpyrrolidone, valerolactam or caprolactam; esters, such as carboxylic acid C₁-C₆ alkyl esters, such as butyl formate, ethyl acetate or propyl propionate; or carboxylic acid C₁-C₆ glycol esters; or glycol ether acetates, such as 1-methoxy-2-propyl acetate; or phthalic acid dialkyl esters or benzoic acid alkyl esters, such as benzoic acid C₁-C₄ alkyl esters or C₁-C₁₂ alkyl phthalic acid diesters; cyclic esters, such as caprolactone; nitriles, such as acetonitrile, aliphatic or aromatic amines, such as n-butylamine, dimethylaniline or diethylaniline, for example; unhalogenated or halogenated aliphatic hydrocarbons such as cyclohexane, methylcyclohexane, methylene chloride, carbon tetrachloride, di-, tri- or tetrachloroethylene, di- or tetrachloroethanes; or aromatic hydrocarbons or mixtures of aromatic and aliphatic hydrocarbons such as benzene, benzines or pinene; or alkyl-, alkoxy-, nitro-, cyano-, carboxy- or halogen-substituted aromatic hydrocarbons such as, for example, toluene, xylenes, ethylbenzene, anisole, nitrobenzene, chlorobenzene, dichlorobenzenes, trichlorobenzenes, benzonitrile, benzoic acid or bromobenzene; or other substituted aromatics, such as phenols, aminophenols, cresols, nitrophenols, phenoxyethanol or 2-phenylethanol; aromatic heterocycles, such as pyridine, morpholine, picoline or quinoline; 1,3-dimethyl-2-imidazolidinone; sulfones and sulfoxides, such as dimethyl sulfoxide and sulfolane; and also mixtures of these organic liquids. Preference is given to using those which have crystallizing and/or phase-determining properties. Preference is given to using glycols and glycol ethers, such as ethylene glycol, diethylene glycol or butyl glycol, amines, such as aniline, diethylaniline, dimethylaniline, n-butylamine, o-toluidine or tallow fatty propylenediamine, dimethylformamide, N-methylpyrrolidone, triethanolamine, toluene, xylene, cumene, mesitylene, diisopropylnaphthalene or octylbenzene.

For the milling it is additionally possible for acids to be employed as well. The acids known from the literature can be used. Preference is given to using phosphoric acid, formic acid, acetic acid, methanesulfonic acid, dodecylbenzene-sulfonic acid, and, in particular, sulfuric acid.

Pulverulent solids are able to absorb a certain amount of liquid without losing their free-flowing consistency. If organic liquids and/or acid are used, it is in amounts such that the millbase retains a dry, i.e., pourable or free-flowing consistency. Larger amounts lead to caking and cementing of the millbase to the grinding media and to the walls of the mill. The possible maximum amounts of organic liquid and/or acid may vary greatly, and depend on the composition of the millbase and on the resultant fineness and hence on the surface area of the crystallites in the course of milling. Commonly the amounts are 0% to 15% by weight, preferably 1% to 10% by weight based on crude pigment.

If grinding assistants, organic liquids or acids have been used in the course of the milling, they can be removed prior to an aftertreatment. This is advisable particularly when relatively large amounts of these additives are employed. To perform such removal the millbase is stirred with water to give an aqueous suspension and the additives are dissolved and separated from the prepigment by filtration. With respect to this treatment it has proven appropriate to set an acidic pH by adding acid, hydrochloric acid or sulfuric acid for example. It is also possible to select an alkaline pH, in order, for example, to dissolve an acid that has been used. A further possibility is to dispense with removal, particularly when small amounts of grinding assistants, organic liquids or acids are used. These components may also be dissolved by the water used in the case of finishing, and/or may be neutralized by means of a corresponding amount of base.

In the course of milling in accordance with the method of the invention it is possible to employ further auxiliaries, such as, for example, surfactants, nonpigmentary and pigmentary dispersants, fillers, standardizers, resins, waxes, defoamers, antistats, antidust agents, extenders, shading colorants, preservatives, drying retardants, rheology control additives, wetting agents, antioxidants, reductants, UV absorbers, light stabilizers, or a combination thereof.

In accordance with the method of the invention, therefore, it is possible to produce not only dioxazine pigments but also dioxazine pigment preparations.

Suitable surfactants include anionic or anion-active, cationic or cation-active, and nonionic or amphoteric substances, or mixtures of these agents, as set out in WO-2004/052997 and WO-2004/052996, for example.

Nonpigmenting dispersants are substances not structurally derived from organic pigments, as recited in WO-2004/052997 and WO-2004/052996, for example. As dispersants they are added either during actual pigment preparation or else often during incorporation of the pigments into the application media that are to be colored; for example, in the preparation of paints or printing inks, they are added by dispersing the pigments in the corresponding binders.

By pigmentary dispersants are meant pigment dispersants known per se which derive from an organic pigment parent structure and are prepared by chemically modifying that parent structure, examples being saccharin-containing pigment dispersants, piperidyl-containing pigment dispersants, naphthylene- or perylene-derived pigment dispersants, pigment dispersants having functional groups which are attached to the pigment parent structure via a methylene group, pigment parent structures modified chemically with polymers, pigment dispersants containing sulfo acid, sulfonamide or sulfo acid ester groups, pigment dispersants containing ether or thioether groups, or pigment dispersants containing carboxylic acid, carboxylic ester or carboxamide groups. Examples of such dispersants are described in EP-A-0 321 919, EP-A-0 489 421 or EP-A-0 538 784. Preference is given to using those pigment dispersants which derive structurally from PV 23 as parent structure, particular preference among them being given to those linked via a methylene group to the pigment parent structure.

In the method of the invention it is possible to employ one or more pigment dispersants in a total amount of 0.1% to 25% by weight, preferably 0.5% to 20% by weight, in particular 1.0% to 17.5% by weight, based on the weight of the crude pigment.

Fillers and extenders refer to a multiplicity of substances in accordance with DIN 55943 and DIN EN 971-1, examples being the various types of talc, kaolin, mica, dolomite, lime, barium sulfate or titanium dioxide.

After the milling the dioxazines are frequently in the form of prepigments, whose performance properties do not as yet satisfy the requirements. Therefore, milling is frequently followed by an aftertreatment, which may be, for example, a treatment in a liquid aqueous, aqueous-organic or organic medium, where appropriate at elevated temperature, called a finish hereinbelow, or else may be a wet dispersion. For the aftertreatment it is possible to employ the prepigments directly in dry form or, after removal of the grinding assistants, in dried form, or in presscake form.

In the case of a finish the milled dioxazine is subjected to treatment in an aqueous, aqueous-organic or purely organic, one-phase, multiphase or emulsionlike solvent system. Usually, elevated temperatures up to 200° C. are selected, and superatmospheric pressure is employed where appropriate. The treatment may last between 5 minutes and 24 hours; longer times are of course possible but are usually uneconomic.

During the finish or else even during milling it is possible for anionic groups of the nonpigmentary or pigmentary dispersants, surfactants or resins, employed as auxiliaries, to be laked, by means for example of Ca, Mg, Ba, Sr, Mn or Al ions or by means of quaternary ammonium ions, or they are employed already in laked form.

The wet dispersion carried out for the purpose of aftertreatment may take place in the customary batch or continuous roll mills or bead mills, and stirred ball mills with a high energy density can also be employed. Grinding media used are balls, and milling can be carried out in aqueous, aqueous-organic or purely organic, one-phase, multiphase or emulsionlike solvent systems. Here it is possible to employ acids or bases, bases being preferred. The pigment concentration in the millbase is dependent on the rheology of the suspension and on the selected type of mill, and is advantageously not more than 40% by weight of the millbase suspension. Generally temperatures of 0 to 100° C. are selected. The duration of dispersing depends on the desired requirements.

Organic liquids which may be employed for the aftertreatment suitably include the organic liquids recited above in connection with the milling, and mixtures of such liquids. It is preferred to use those which have crystallizing and/or phase-determining properties. Preferred solvents are C₁-C₆ alcohols, especially methanol, ethanol, n- and isopropanol, isobutanol, n- and tert-butanol, and tert-amyl alcohol; C₃-C₆ ketones, especially acetone, methyl ethyl ketone or diethyl ketone; tetrahydrofuran, dioxane, glycols and glycol ethers, such as ethylene glycol, diethylene glycol or ethylene glycol C₃-C₅ alkyl ethers, especially 2-methoxyethanol, 2-ethoxyethanol, butyl glycol, n-butylamine, dimethyl-formamide, dimethylacetamide, N-methylpyrrolidone, benzoic acid C₁-C₄ alkyl esters, toluene, xylene, ethylbenzene, chlorobenzene, o-dichlorobenzene, trichlorobenzenes, nitrobenzene, phenol, nitrophenols, pyridine, quinoline, dimethyl sulfoxide, cyclohexane or methylcyclohexane.

In the case of an aftertreatment it is possible in certain circumstances, especially when using only small amounts of grinding assistants, organic liquids or acids during milling, to forego their removal prior to aftertreatment. In that case the millbase is subjected directly to the aftertreatment, and the grinding assistants, organic liquids or acids are removed using the solvent system employed for the aftertreatment.

In the case of solvents which can be separated from an aqueous phase by steam distillation it is appropriate to remove them in that way prior to isolation, particularly when recovery of the solvent employed is desired.

Other solvents, especially esters, can be destroyed by hydrolysis after the aftertreatment and can be removed relatively easily in that way.

In the case of corresponding performance requirements it is possible for the dioxazine pigments or prepigments to be present in the desired form after milling alone, so that they no longer require any further aftertreatment and can be employed directly after milling, or they require merely the above-outlined removal of grinding assistants employed. This is appropriate especially in the case where the dioxazine pigments are employed in printing ink systems, since in that case, during the incorporation of the colorant into the printing ink system or into the binder of the printing ink system, it is often possible for an aftertreatment similar to a finish to take place and also, where appropriate, for a desired change in crystal polymorph to occur.

The millbases produced by the method of the invention have a dry, i.e., pourable, free-flowing consistency; following the removal of the grinding assistants or following the aftertreatment, the prepigments, pigments or pigment preparations are in suspension form and can be isolated by the customary methods, such as by filtration, decanting or centrifuging, for example. Solvents can also be removed by washing. The prepigments, pigments and pigment preparations can be employed as preferably aqueous presscakes, but are generally dried, solid systems of free-flowing, pulverulent consistency, or are granules.

The auxiliaries can also be added only after the milling, at any desired step of the aftertreatment or isolation.

The pigments and pigment preparations produced by the method of the invention can be used for pigmenting high molecular mass organic materials of natural or synthetic origin, such as plastics, resins, varnishes, paints, electrophotographic toners and developers, electret materials, color filters, and also inks, including printing inks, and seed.

It was surprising and unforeseeable that through the use of a vibratory mill operating with the eccentric vibration principle, counter to the teaching of Gock, E. and Corell, J., it is possible to comminute dioxazines in a way which is more economic as compared with conventional vibratory mills, yet still to produce dioxazine pigments of high transparency. Also surprising and unforeseeable was the fact that the dioxazine pigments produced by the method of the invention also possess, additionally, high gloss, color strength, dispersibility, cleanness of hue, and good rheology. Another surprising finding was that it is possible to carry out grinding with higher quantities of organic solvent than in a conventional vibratory mill, in other words one operating on the centric vibration principle, without instances of caking of the millbase. As a result of the use of the eccentric milling principle, therefore, the range of use of vibratory milling is significantly extended.

The BET surface area is determined in accordance with DIN 66132.

The particle size distribution is determined by means of electron microscopy; 50% by volume of the particles have an average diameter equal to or less than the figure referred to as the D50. The D50 figure is determined by manual evaluation on a graphics tablet. The particles encompassed by this determination are the primary particles.

In order to assess the properties of the pigment preparations in the coatings sector a selection was made, from among the multiplicity of known varnishes, of an aromatics-containing alkyd-melamine resin varnish (AM) based on a medium-oil alkyd resin and on a butanol-etherified melamine resin.

The coloristic properties were determined in accordance with DIN 55986.

Following the dilution of the millbase to the final pigment concentration, the viscosity was assessed using the Rossmann viscospatula, type 301 from Erichsen.

Gloss measurements were made on film castings, from an angle of 20° in accordance with DIN 67530 (ASTMD 523), using the “multigloss” gloss meter from Byk-Mallinckrodt.

In the examples which follow, parts and percentages are by weight unless indicated otherwise.

### EXAMPLE 1a

A vibratory mill operating on the eccentric vibration principle in accordance with EP-A1-0 653 244 is charged with iron rods as grinding media. The grinding media filling level is 65%. The millbase is composed of crude synthesis-salt-containing dioxazine pigment P.V. 23, sodium chloride, and diethylene glycol in a weight ratio of 4:6:1. The millbase filling level is 80%. Milling is carried out for 90 minutes.

### EXAMPLE 1b

The millbase from example 1a is desalted by stirring in 4 times the amount of water at 60° C. for an hour, the suspension is filtered with suction, and the presscake is washed free of salt. The aqueous presscake has a dry-matter content of 41.3% by weight.

### EXAMPLE 1c

222.6 parts of 41.3% by weight aqueous presscake produced in accordance with example 1b are stirred in 139 parts of tert-amyl alcohol, 191.0 parts of water, and 0.92 part of a sodium salt of an olefin sulfonate and the mixture is homogenized at room temperature for a while. The mixture is subsequently stirred at boiling temperature for 5 hours. Then the tert-amyl alcohol is distilled off, dilution is carried out with 95 parts of water, the suspension is filtered with suction, and the presscake is washed to neutrality and dried. This gives 93.2 parts of dioxazine pigment preparation. The BET surface area is 71 m²/g.

### COMPARATIVE EXAMPLE 2A/B

The experimental conditions of example 1a are applied to a vibratory mill which operates on the conventional, centric vibration principle. The millbase is desalted in accordance with the conditions of example 1b. The aqueous presscake has a dry-matter content of 45.8% by weight.

### COMPARATIVE EXAMPLE 2C

An aftertreatment in accordance with example 1c is carried out with presscake produced in accordance with comparative example 4A/B.

### COMPARISON OF EXAMPLE 1c WITH COMPARATIVE EXAMPLE 2C

The pigment preparation produced in accordance with example 1c using the eccentric vibratory milling principle exhibits high color strength, transparency, gloss, and low viscosity in the AM varnish.

| Example 1c | Comparative example 2C |
|---|---|
| eccentric milling principle | conventional milling principle |
| Markedly higher color strength than | Markedly lower color strength than |
| comparative example 2C | example 1c |
| Somewhat more transparent than | Somewhat more hiding than |
| comparative example 2C | example 1c |
| Gloss value 83 | Gloss value 75 |
| Viscosity 6.8 sec | Viscosity 8.8 sec |
| BET surface area: 70.9 m²/g | BET surface area: 68.1 m²/g |

### EXAMPLE 3a

A vibratory mill operating on the eccentric vibration principle in accordance with EP-A1-0 653 244 is charged with iron rods as grinding media. The grinding media filling level is 65%. The millbase is composed of crude synthesis-salt-containing dioxazine pigment P.V. 23 and sodium chloride, in a weight ratio of 1:2. The millbase filling level is 90%. Milling is carried out for 120 minutes. The millbase yield is 98.3% by weight of the millbase employed. The small loss is due to dusting during the filling and emptying operation.

### EXAMPLE 3b

The millbase from example 3a is desalted by stirring in 4 times the amount of water at 60° C. for an hour, the suspension is filtered with suction, and the presscake is washed free of salt. The aqueous presscake has a dry-matter content of 35.0% by weight.

### EXAMPLE 3c

261.4 parts of 35.0% by weight aqueous presscake produced in accordance with example 3b are stirred in 139 parts of tert-amyl alcohol, 152.2 parts of water, and 0.92 part of a sodium salt of an olefin sulfonate and the mixture is homogenized at room temperature for a while. The mixture is then stirred at boiling temperature for 5 hours. Then the tert-amyl alcohol is distilled off, dilution is carried out with 95 parts of water, the suspension is filtered with suction, and the presscake is washed to neutrality and dried. This gives 89.9 parts of dioxazine pigment preparation. The BET surface area is 30 m²/g.

### COMPARATIVE EXAMPLE 4A/B

The experimental conditions of example 3a are applied to a vibratory mill which operates on the conventional, centric vibration principle. The millbase yield is drastically lowered and is only 87.2% by weight of the millbase employed. The loss arises through caking of the millbase on the iron rods and on the walls, the millbase being so firmly cemented that it has to be chiseled out in order to clean the mill.

The millbase is desalted in accordance with the conditions of example 3b. The aqueous presscake has a dry-matter content of 36.1% by weight.

### COMPARATIVE EXAMPLE 4C

An aftertreatment in accordance with example 3c is carried out with presscake produced in accordance with comparative example 4A/B.

### COMPARISON OF EXAMPLE 3c WITH COMPARATIVE EXAMPLE 4C

The pigment preparation produced in accordance with example 3c using the eccentric vibratory milling principle exhibits high color strength, transparency, gloss, low viscosity, and a higher BET surface area in the AM varnish.

| Example 3c | Comparative example 4C |
|---|---|
| eccentric milling principle | conventional milling principle |
| Markedly higher color strength as | Markedly lower color strength as |
| compared with comparative example 4C | compared with example 3c |
| Somewhat more transparent than | Somewhat more hiding than |
| comparative example 4C | example 3c |
| Gloss value 84 | Gloss value 71 |
| Viscosity 21.8 sec | Viscosity 29.5 sec |
| BET surface area: 29.8 m²/g | BET surface area: 24.9 m²/g |

### EXAMPLE 5a

A vibratory mill operating on the eccentric vibration principle in accordance with EP-A1-0 653 244 is charged with iron rods as grinding media. The grinding media filling level is 65%. The millbase is composed of crude synthesis-salt-containing dioxazine pigment P.V. 23, sodium chloride, and diethylene glycol, in a weight ratio of 8:12:1. The millbase filling level is 80%. Milling is carried out for 90 minutes.

### EXAMPLE 5b

The millbase from example 5a is desalted by stirring in 4 times the amount of water at 60° C. for an hour, the suspension is filtered with suction, and the presscake is washed free of salt. The aqueous presscake has a dry-matter content of 34.3% by weight.

### EXAMPLE 5c

266.8 parts of 34.3% by weight aqueous presscake produced in accordance with example 5b are stirred in 139 parts of tert-amyl alcohol, 146.8 parts of water, and 0.92 part of a sodium salt of an olefin sulfonate and the mixture is homogenized at room temperature for a while. The mixture is then stirred at boiling temperature for 5 hours. Then the tert-amyl alcohol is distilled off, dilution is carried out with 95 parts of water, the suspension is filtered with suction, and the presscake is washed to neutrality and dried. This gives 90.9 parts of dioxazine pigment preparation. The BET surface area is 25 m²/g.

### COMPARATIVE EXAMPLE 6A/B

The experimental conditions of example 5a are applied to a vibratory mill which operates on the conventional, centric vibration principle. The millbase yield is 91%. The loss arises through caking of the millbase on the iron rods and on the walls; in order to clean the mill it is necessary to remove the millbase by scratching, with a relatively high level of force applied. The millbase is desalted in accordance with the conditions of example 5b. The aqueous presscake has a dry-matter content of 41.6% by weight.

### COMPARATIVE EXAMPLE 6C

An aftertreatment in accordance with example 5c is carried out with presscake produced in accordance with comparative example 6A/B.

### COMPARISON OF EXAMPLE 5c WITH COMPARATIVE EXAMPLE 6C

The pigment preparation produced in accordance with example 5c using the eccentric vibratory milling principle exhibits high color strength, transparency, gloss, and low viscosity in the Am varnish-.

| Example 5c | Comparative example 6C |
|---|---|
| eccentric milling principle | conventional milling principle |
| Significantly higher color strength than | Markedly lower color strength |
| comparative example 6C | than example 5c |
| Markedly more transparent than | Markedly more hiding than |
| comparative example 6C | example 5c |
| Gloss value 84 | Gloss value 56 |
| Viscosity 8.2 sec | Viscosity 8.4 sec |

### EXAMPLE 7

A vibratory mill operating on the eccentric vibration principle in accordance with EP-A1-0 653 244 is charged with iron rods as grinding media. The grinding media filling level is 65%. The millbase is composed of crude synthesis-salt-containing dioxazine pigment P.V. 23, sodium chloride, and diisopropylnaphthalene, in a weight ratio of 10:4:1. The millbase filling level is 70%. Milling is carried out for 2 hours. The millbase yield is 98.3%. The small loss comes about as a result of the filling and emptying operation.

The millbase is desalted by stirring in 4 times the amount of water at 60° C. for an hour, the suspension is filtered with suction, and the presscake is washed free of salt.

The presscake is subjected to aftertreatment in the same way as in example 3c.

### COMPARATIVE EXAMPLE 8

Example 7 is carried out with the sole difference that a vibratory mill operating on the conventional vibratory principle is employed instead of the eccentric mill. The millbase yield is below 86.1%, due to caking.

### COMPARISON OF EXAMPLE 7 WITH COMPARATIVE EXAMPLE 8

The pigment preparation from example 7 yields strongly colored transparent colorations with a high gloss and good flow properties in the AM varnish.

| Example 7 | Comparative example 8 |
|---|---|
| eccentric milling principle | conventional milling principle |
| Somewhat higher color strength as | Somewhat lower color strength |
| compared with comparative example 8 | as compared with example 7 |
| Somewhat more transparent than | Somewhat more hiding than |
| comparative example 8 | example 7 |
| Gloss value 80 | Gloss value 63 |
| Viscosity 6.3 sec | Viscosity 8.3 sec |

1) A method for producing a transparent dioxazine pigment comprising the steps of comminuting a crude dioxazine pigment using an eccentric vibration mill having at least one milling container mounted on vibratory elements and having an energizer unit fastened rigidly to the at least one milling container, wherein the comminuting step includes energizing the crude dioxazine pigment, wherein the energizing taking place eccentrically to one side and outside the gravitational axis and the center of gravity of the at least one milling container, so that inhomogeneous vibrations consisting of circular, elliptical, and linear vibrations are generated.

2) The method as claimed in claim 1, wherein the dioxazine pigment is C.I. Pigment Violet 23, C.I. Pigment Violet 37 or C.I. Pigment Blue 80.

3) The method as claimed in claim 1, wherein the comminuting is carried out at a temperature between 0 and 150° C.

4) The method as claimed in claim 1, wherein the comminuting is carried out in the presence of alkali metal salts or alkaline earth metal salts.

5) The method as claimed in claim 1, wherein the comminuting is carried out in the presence of 0% to 15% by weight, based on the crude dioxazine pigment, of organic solvent.

6) The method as claimed in claim 1, wherein the comminuting is carried out in the presence of at least one auxiliary selected from the group consisting of surfactants, dispersants, fillers, standardizers, resins, waxes, defoamers, antistats, antidust agents, extenders, shading colorants, preservatives, drying retardants, rheology control additives, wetting agents, antioxidants, reductants, UV absorbers, light stabilizers, and a combination thereof.

7) The method as claimed in claim 1, wherein following the comminuting the method further comprises solvent finishing the crude dioxazine pigment.

8) A transparent dioxazine pigment made in accordance with the method of claim 1.
